(19) United States
(12) Patent Application Publication
(10) Pub. No.: US 2003/0046231 A1
(43) Pub. Date: Mar. 6, 2003

(54) Access terminal for telecommunication and automated teller machine services

(76) Inventor: Robert Wu, Princeton Junction, NJ (US)

Correspondence Address: Alen R. Kipnes, WATOV & KIPNES, P.C., P.O. Box 247, PRINCETON JUNCTION, NJ, 08550, US

(21) Appl. No.: 09/944,270

(22) Filed: Aug. 31, 2001

(51) Int. Cl. G06F 17/60

(52) U.S. Cl. 705/43

(57) ABSTRACT

The present invention is generally directed to an access terminal maintained by a service provider and connected to a global communications network for furnishing telecommunications and automated teller machine (ATM) services to a customer, where the access terminal comprises a microcontroller for executing preprogrammed instructions and generating directives, a payment acceptor electrically connected and responsive to the microcontroller for accepting payment from the customer to pay for access to the services, a multimedia user interface electrically connected and responsive to the microcontroller for enabling exchange of information between the customer and the access terminal during access to the services upon accepting payment from the customer, the multimedia user interface including an ATM interface in one mode of operation for executing an ATM/POS financial transaction by the customer via the global communications network, and a network interface device electrically connected and responsive to the microcontroller for connecting to a service provider server through the global communications network.

### FIELD OF THE INVENTION

The present invention relates to computer service terminals, and more particularly, to service access terminals connected to, and communicate through a global communications network such as the Internet, for providing services such as ATM/POS financial transaction service, telephone and facsimile calling service, and computer access over the global communications network.

### BACKGROUND OF THE INVENTION

The proliferation of automated teller machines (ATMs) have increased rapidly for the past several years. Typically, ATMs utilize point of sale (POS) terminals connected through a dedicated ATM network for carrying out financial transactions. This type of on-line ATM/POS transaction is performed at ATM machines or merchant point of sale (POS) terminals directly connected to the ATM network. For this type of transaction, a customer swipes their ATM card, debit or check card, and enters their personal identification number (PIN), whereby the network recognizes as an on-line ATM/POS transaction and routes it through the same network that is used for ATM transactions. As part of that routing process, the network is set up to route the transaction according to a Bank Identification Number (BIN) included in a Primary Account Number (PAN), which is embossed on the card. The embossed number on the card is also stored on the magnetic stripe of the card, or for a smart card, within the memory of the microcomputer chip on the card.

An on-line ATM/POS transaction provides the customer with immediate cash, or transfer funds electronically to another such as a merchant from the customer's existing savings or checking account. This is beneficial to both the customer and the merchant. For the customer who would normally roll-over some or all of a credit card transaction, the on-line ATM/POS transaction is beneficial because it saves the customer from having to pay finance charges typically associated with credit cards. For the merchant, an on-line ATM/POS transaction is beneficial because the cost to the merchant for this type of transaction is based on a fixed fee. The fixed fee is typically less than the percentage of the transaction amount charged for credit transactions, especially for transaction amounts over $12 to $15 U.S. dollars. Thus, on-line ATM/POS transactions are typically more desirable to the merchant for these dollar amount transactions, and convenient for the customer.

Conventional ATM/POS transactions, however, are typically performed at sources that are directly connected to the ATM/POS network and maintained by an ATM/POS network provider which is typically the participating banks and financial institutions. The sources capable of carrying out conventional ATM/POS transactions are often few in number and costly for merchants maintaining such sources. Currently, there is no mechanism that securely connects the ATM network to the Internet through which customers may gain inexpensive and wide access in a public area such as airports, convention centers, bus terminals, shopping centers, restaurants and the like. Access to the ATM network is typically provided only though such limited ATM and POS merchant sources connected to the dedicated ATM network.

There is a need for an access terminal connected to, and communicates through a public accessible global communications network such as the Internet, and adapted to provide services including ATM/POS financial transactions, telephone and facsimile calling, and Internet computer access such as world wide web (WWW) browsing. There is a further need to provide low cost access to savings and checking accounts to perform ATM/POS financial transactions through a global communications network (i.e., the Internet) in a secure cost efficient and convenient manner.

### SUMMARY OF THE INVENTION

The present invention is generally directed to an access terminal maintained by a service provider and connected to a global communications network for furnishing telecommunications and automated teller machine (ATM) services to a customer, in which the access terminal comprises:

a microcontroller for executing preprogrammed instructions and generating directives;

a payment acceptor electrically connected and responsive to the microcontroller for accepting payment from the customer to pay for access to the services;

a multimedia user interface electrically connected and responsive to the microcontroller for enabling exchange of information between the customer and the access terminal during access to the services upon accepting payment from the customer, the multimedia user interface including an ATM interface in one mode of operation for executing an ATM/POS financial transaction by the customer via the global communications network; and

a network interface device electrically connected and responsive to said microcontroller for connecting to a service provider server through the global communications network.

In another particular aspect of the present invention, there is provided an access terminal network maintained by a service provider for furnishing telecommunications and automated teller machine (ATM) services to a customer, wherein the network comprises:

an access terminal comprising a multimedia user interface for enabling exchange of information between the customer and the access terminal during access to the services, the multimedia user interface including an ATM interface in one mode of operation for executing an ATM/POS financial transaction by the customer;

a remote service provider server connected and in operative communication with a service provider gateway server; and

a global communications network connecting the access terminal and the remote service provider server for facilitating data communication therebetween.

### BRIEF DESCRIPTION OF THE DRAWINGS

The following drawings in which like reference characters indicate like parts are illustrative of embodiments of the invention and are not to be construed as limiting the invention as encompassed by the claims forming part of the application.

FIG. 1 is a front perspective view of an embodiment of an access terminal for telecommunication and automated teller machine (ATM) services according to the present invention;

FIG. 2 is a schematic diagram illustrating the components of an embodiment of the access terminal according to the present invention; and

FIG. 3 is a schematic diagram of an access terminal communications network for providing telephone and facsimile calling service, Internet computer access service, and automated teller service through the access terminal according one embodiment of the present invention.

### DETAILED DESCRIPTION OF THE INVENTION

The present invention is directed to an access terminal for telecommunication and automated teller machine (ATM) services specifically on-line ATM/POS transaction capability over a public access global communications network, such as the Internet in a cost effective manner. The present invention beneficially permits a customer the convenience of utilizing savings or checking account funds in an on-line ATM/POS transaction from a source that is remote from the on-line ATM/POS transaction system, thereby effectively executing an external ATM/POS transaction that is performed online and in real time. It is understood that the term “customer” refers to a party that is the rightful owner of, or rightfully has access to, the savings and checking account that comprises the funds or value by the customer in the transaction.

The access terminal of the present invention further includes safeguards for ensuring the customer is entitled to the respective funds such as the provision of the bank access card, the name identifications, a card number used as a source of value for debiting and corresponding bank PIN for authenticating the customer as the rightful owner of the card number. Although, as one skilled in the art realizes, many other similar financial transactions may be performed by the access terminal of the present invention. Therefore, the customer may access the access terminal by inserting a prepaid card and then a bank card into a card reader, responding to prompts on a display, and retrieving the money and a receipt. Such terminals may be located at safe areas of public places including supermarket, convenience stores, and travel centers.

In one aspect of the present invention allows any customer with a valid ATM card or bank access card issued by a financial institution, to access the access terminal of the present invention on a charge rate basis in order to utilize their savings or checking account in an on-line ATM/POS transaction over the Internet. Additionally, the present invention may also be utilized for numerous other transactions involving savings or checking accounts to pay bills electronically, perform electronic fund transfers, and other transactions using conventional Internet file transfer protocols.

In another aspect of the present invention, the access terminal is equipped to provide telephone and facsimile calling through the Internet and the public switched telephone network (PSTN), and computer access to the global communications network such as the Internet using World Wide Web data transfer protocols. The access terminal is preferably connected to the global communications network for facilitating access to the remote central server for access to the telecommunications and ATM services.

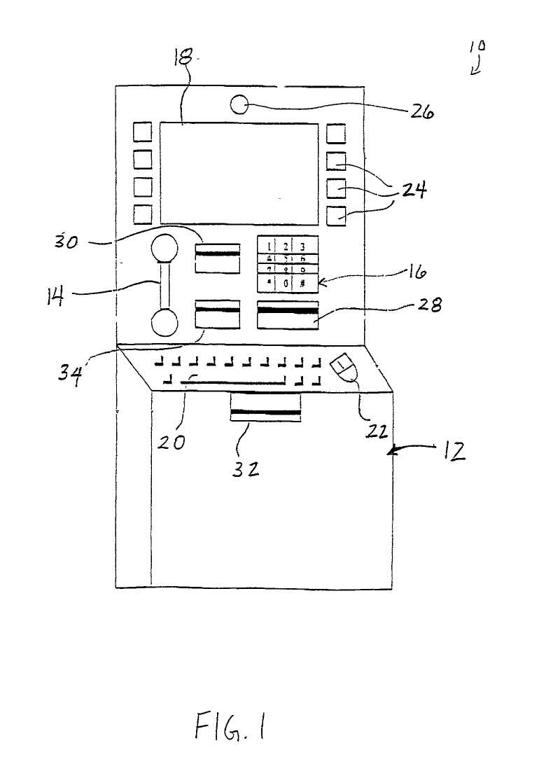

Referring to FIG. 1, an access terminal 10 for telecommunication and ATM services, is shown for one embodiment of the present invention. The access terminal 10 includes a housing 12 for securing and accommodating the component parts in a single unit. The access terminal 10 is adapted to provide high speed Internet computer access, telephone and facsimile calling service, and financial transaction service from a publically accessible location. The access terminal 10 includes any suitable input and output devices for facilitating a multimedia interface with the customer. The term “multimedia interface” refers to the point of interaction or communication through combined use of one or more media between the computer terminal and the customer. Such media may include a range of formats such as text, graphics, animation, audio, video and the like. The access terminal 10 may be placed at any location that is publicly accessible such as in convenience stores, malls, restaurants, etc. A customer can simply walk up to the access terminal 10 for easy access to the offered services at any time.

The access terminal 10 includes a microcontroller (not shown), a currency acceptor 30, a currency dispenser 32, and multimedia user interface means including a single line telephone handset 14, a single line push-button dial pad 16, a monitor 18 such as a 15-inch liquid crystal display, user input devices including a keyboard 20, a mouse pointing device 22, and a plurality of function keys 24, a universal serial bus compatible camera device 26, a card reader 28 such as a magnetic stripe reader, and a printer device 34 such as a thermal printer. As used herein, the term “multimedia user interface means” covers all suitable user input and output peripheral devices including but not limited to monitors, card readers, microphones, cameras, keyboards, pointing devices, speakers, printers, and the like, through which, in combination, exchanges information with the customer in a range of formats such as text, graphics, animation, audio, video and the like. The multimedia user interface means enables the customer to effectively convey and receive information with and through the access terminal 10.

In addition, the access terminal 10 further includes a network interface device (not shown) for connection with suitable communications channels such as ethernet networks, frame relay networks, synchronous optical network (SONET), asynchronous transfer mode (ATM) networks, digital subscriber loop (xDSL) networks, cable networks, satellite link, T1/T3/E1 trunk lines, integrated services digital network (ISDN), and the like for data transfer through a global communications network (i.e., the Internet). In a preferred form of the invention, the access terminal 10 is connected to, and communications with a remote central server directly over a dedicated communications channel such as through a broadband connection carrier system for enabling continuous high speed data connection. The remote central server provides a gateway through which all the access terminals of the present invention become available to the customer.

The customer may choose to access the Internet such as the World Wide Web (WWW) for web browsing and the like, access telephone calling service such as Internet telephone calling and telephone calling or facsimile data transmission through a public switch telephone network (PSTN), or carrying out financial transactions such as cash withdrawals or electronic fund transfers from checking or savings accounts, through the access terminal 10 for a fixed fee. The WWW is a graphical user interface system that facilitates access to information on the Internet by organizing it into pages. WWW also provides hyperlinks, which, when “clicked” with a mouse, downloads the corresponding page located at an IP address that contains the implied information. In accordance with a further aspect of the present invention, a prepaid card can be suitably employed in context of a prepaid fee arrangement for accessing the above described services. The prepaid card includes information necessary to allow a customer to draw upon a prepaid account purchased by the customer. In the context of the present invention as set forth herein, the prepaid account corresponds to a prepaid card for initiating telephone calling, transmitting a document via facsimile, implementing Internet service access and/or executing financial transactions through the access terminal 10.

The prepaid card has associated therewith an ID number or PIN and optionally a customer-selected password through which a customer may access the access terminal 10 operated by a prepaid service provider. Upon inputting the ID number or PIN in association with the customer-selected password in response to a prompt from a remote service provider host computer or server to authenticate a customer. Upon authentication, a search is performed on a prepaid card database to determine whether sufficient funds or balance amounts exist to permit customer access to the access terminal 10. If not, the customer is informed that the prepaid account has no funds, and is invited to purchase a new prepaid card or replenish the existing prepaid card through a prepaid card terminal or participating retail vendor. Alternatively, the customer may deposit currency such as bank notes or coins into the access terminal 10 or use a credit or debit card to secure access to the access terminal 10 of the present invention. If sufficient funds are available, the customer is permitted proceed to access the services.

For increased security, the prepaid card may be associated with a password code selected by the customer at the time of purchase of the prepaid card or access to participating point of service terminals. The customer-selected password code is transmitted and securely stored on a central database in the remote host computer or server maintained by the prepaid service provider corresponding to the prepaid card's PIN. The central database may be adapted to store the PINs and the corresponding customer-selected password codes of the activated prepaid cards. Thus, to access services offered by the prepaid service provider (e.g. prepaid telephone and Internet service), the customer is prompted to supply both the PIN and the customer selected password code, before providing service access. In this manner, the prepaid card cannot be used by unauthorized persons. If the customer's prepaid card is stolen or lost, a replacement prepaid card may be issued with the same PIN. The customer of the prepaid card may optionally be permitted to change the password code periodically at the prepaid card vendor or participating point of service terminals for added security.

It will be understood the prepaid card may include a local memory component. For example, information regarding balance amount, and perhaps other useful information relating to the account may be stored directly on the prepaid card, for example, in a random access memory module, microprocessor and the like. In such instances, it is preferably to maintain a central database in a remote central server for storing and updating such information. In circumstances where communication is established with the remote central server each time the prepaid card is used, even cards with a local memory component may be effectively “canceled” or “inactivated”, if the prepaid card are determined to be lost or stolen and the corresponding password code is compromised. In this manner, the remote central server would be in position to authorize the use of the prepaid card each time or at least be in a position to prevent any unauthorized use.

If the prepaid account has sufficient funds or balance amounts to enable Internet computer access, telephone calling service, document facsimile transmission or ATM/POS financial transactions, the customer is prompted to enter the requisite information such as telephone number of the desired destination, IP address of the server for access, or the financial account and financial institution. The customer would be connected to the desired destination, and permitted access to the services until the available balance amount on the prepaid card is depleted.

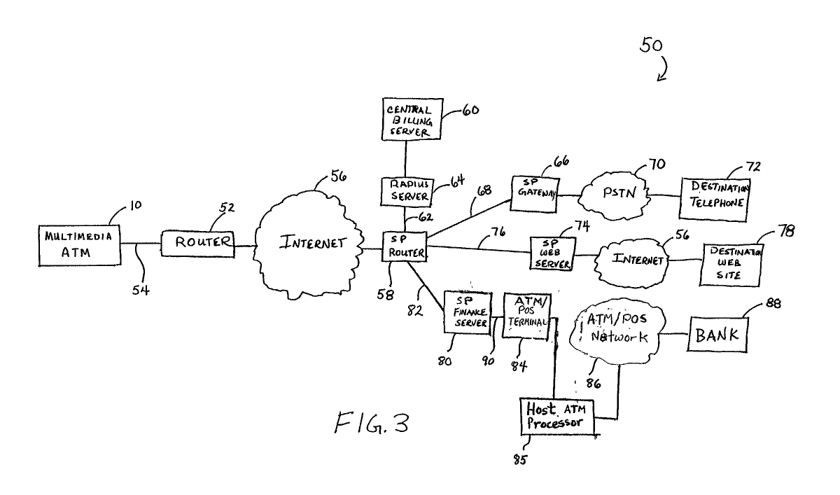

Alternatively, the access terminal 10 may be configured to provide telephone or facsimile service by connecting through the global communications network (i.e. Internet) to a toll-free access line on a PSTN. The access terminal 10 enables the customer to make a telephone or facsimile call upon proper authentication. The telephone or facsimile call is connected to a suitable gateway router (see FIG. 3) on the Internet. The gateway router connects to a dedicated toll-free access line (e.g. 800, 877, 888, and 866 prefix PSTN lines) which may be leased or rented to the service provider of the access terminal 10. Upon connection to the access line on the PSTN, the customer is prompted to enter the desired destination PSTN number for voice or data transmission. The customer may connect to any PSTN destination telephone number through the toll-free access line. The service provider of the access terminal 10 is typically charged a flat monthly rate for the toll-free access line, whereupon the customer making the telephone or facsimile call, may be charged by the service provider, for example, on a per minute basis. During connection to the toll-free access line, if the customer inadvertently dials a wrong destination PSTN number, the customer can press a preset function key 24 to reset the system and re-enter the correct destination PSTN number. In addition, when the customer completes the call and wishes to make another call, the customer can press a preset function key 24 to make a new PSTN telephone or facsimile call without having to reconnect with the access line. Once the customer decides to end the service access to the access terminal 10, the gateway router connected to the PSTN terminates the connection therebetween.

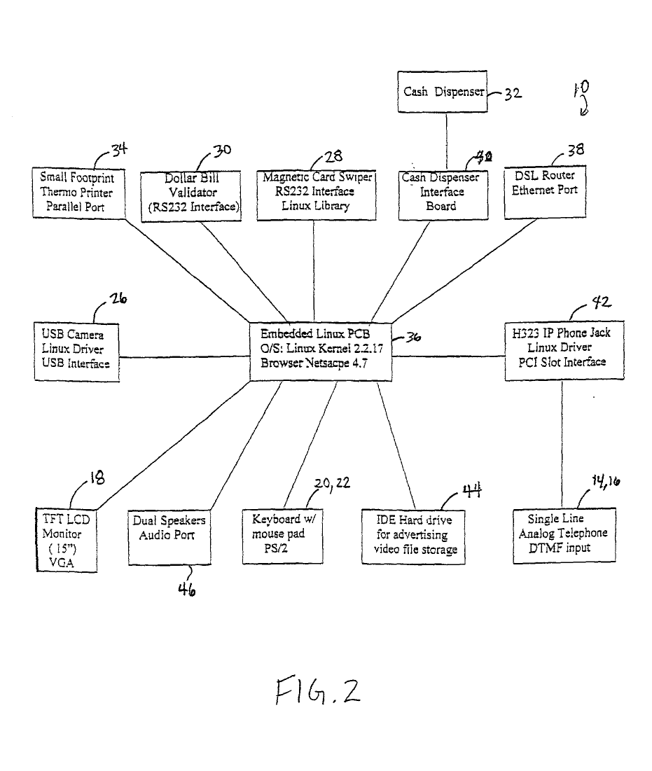

Referring to FIG. 2, the access terminal 10 further includes a memory storage device 44 such as a hard disk drive for storing advertising information, for example, and an audio output device 46 adapted for providing audio messages, instructions and the like to the customer. The microcontroller 36 comprises a microprocessor, read only memory, random access memory, and other features such as a clock, interrupt control, control logic, power, and bus connections. The microcontroller is electronically connected via a bus to the network interface device in the form of a DSL router 38, for example, to the single line telephone handset 14 and the single line push-button dial pad 16 through, for example, a H323 IP phone jack 42, to the monitor 18, to the user input devices including the keyboard 20, the mouse pointing device 22, and the plurality of function keys 24, to the universal serial bus compatible camera device 26, to the card reader 28 such as a magnetic stripe reader, to the currency acceptor 30, to the currency dispenser 32 through a cash dispenser interface 40, and to the printer 34.

The microcontroller is also connected to the memory storage device 44 which has stored therein all of the programs required for operation of the access terminal 10 including, but not limited to, operation of the camera 26, displaying advertising information on the monitor 18 and the audio output device 46, and back up information W and data stored in the flash memory unit of the microcontroller 36. The user input devices such the keyboard 20, the mouse 22 and the function keys 24 allows the customer to input selections, information, data, and the like, in connection with accessing the services offered by the access terminal 10 such as composing email messages, WWW browsing, performing ATM/POS financial transactions, and the like, for example.

The microprocessor may include any suitable central processing unit capable of executing commands and governing the operation of the access terminal 10. The random access memory serves as storage for calculated results, and as stack memory. The read only memory may be configured to store the operating system, fixed data, standard routines, look up tables and the like, in connection with the operation of the access terminal 10. In one embodiment of the present invention, the microcontroller comprises a part of an embedded LINUX main board. The main board includes a central processing unit for data processing, a 32 megabyte flash memory module for storing an operating system, a web browsing and application software, a 64 kilobyte dynamic random access memory, and interface ports for connection with a communications channel and network through the network interface device, the monitor 18, the currency acceptor 30 and the card reader 28 each through a RS232 interface. The microcontroller is preferably equipped with a LINUX operating system software such as Linux Kernel 2.2.17. The web browsing software may include any suitable program such as Netscape Navigator version 4.7, for example, for facilitating file and data transfer and viewing on the Internet. Each of the components such as the card reader 28, the camera 26, and the currency dispenser 32 are interfaced with suitable LINUX-based drivers for enabling compatibility with the operating system.

The telephone handset 14 and dial pad 16 are interfaced through a H323 voice over Internet (VoIP) PCI-compatible board which is adapted to process and convert a 64 kilobyte analog voice signal into 8-12 kilobyte digital packets for transmission over the Internet. The VoIP PCI board performs the analog to digital conversion for efficient transmission of voice conversations over a data network using the Internet protocol. The monitor 18 is adapted to display appropriate visual customer prompts, instructions, and advertising information and data and information conveyed through access of the Internet. The plurality of function keys 24 are provided to permit the customer to input information corresponding to service access selection provided by the access terminal 10 as will be described herein. The camera device 26 allows customers to have photographs taken of themselves for transmission through the Internet in the form of email messages on a per-photo charge basis. In addition, the camera device 26 can also be used to capture video feeds for security applications such as during ATM/POS financial transactions and for video communications applications such as during telephone calls.

The currency acceptor 30, and the card reader 28 are conventionally known structures and the function of each in connection with the present invention will be described herein. The card reader 28 may be adapted to utilize any known card reading techniques including, but not limited to, optical, magnetic, mechanical or electronic means for reading the data contained on the prepaid card. The currency acceptor 30 is a standard bank note acceptor, and accepts paper currency in usual denominations such as $1, $2, $5, $10, etc. The currency acceptor 30 may also include a component adapted for accepting coinage. The currency acceptor 30 has the capability of recognizing and authenticating various currency notes, and if equipped, coins, that the customer may insert in lieu of a prepaid card. The access terminal 10 may optionally include a change making capability in the form of a change dispenser (not shown). The change dispenser may be a known design, and can have a capability of dispensing some combination of coins and/or bank notes.

The card reader 28 is adapted to read the PIN on a prepaid card, or payment related information from a credit or debit card. The card reader 28 generally comprises a magnetic stripe reader configured to read or decode information stored on a strip of magnetic material, usually tape, attached to the card. The information relating to the card such as PIN may be stored thereon and read when passed through the card reader 28. Thus, the access terminal 10 can accept currency, credit card, prepaid card and bank access card for payment through the respective currency acceptor 30 and card reader 28. It is understood that the card reader 28 may be adapted to utilize any known card reading techniques including, but not limited to, optical, magnetic, mechanical or electronic means for reading the data contained on the prepaid or payment card.

The access terminal 10 enables the customer to access their savings or checking accounts to perform ATM/POS financial transactions including, but not limited to, cash withdrawals, electronic fund transfers, bill payments, bank/financial account review, and the like over a public access network. The currency dispenser 32 is adapted to store a number of currency bank notes, typically in the form of $20, and dispenses such bank notes during cash withdrawal transactions. Upon completion of the ATM/POS financial transaction, the printer 34 prints a receipt for the customer to document the ATM/POS financial transactions executed by the customer on the access terminal 10. The access terminal 10 charges the customer a service fee for each financial transaction and the service fee may be efficiently collected from the corresponding transacted bank account or from the prepaid card.

The access terminal 10 also provides facsimile and telephone service and/or Internet computer access allowing customers to make telephone calls and/or access the Internet (e.g. browsing the WWW) to any destination at a per minute charge rate. The customer may also take photographs of themselves for transmission over the Internet through, for example, electronic mail as a per photo charge rate. The access terminal 10 may be adapted to display on the monitor 18 advertising for other services, or for goods or services of third parties to pedestrians and passer-bys. The access terminal 10 may also be adapted to offer personal computer game play for customers and other similar sources of entertainment at a per play or per minute charge rate.

To access the above services offered by the access terminal 10, the customer may purchase a prepaid card, or debit access card from a participating vendor or an automated prepaid card terminal. The access terminal 10 can also be adapted to accept debit, credit, and bank access cards for payment of services and implementing financial transactions. The prepaid card is typically a piece of credit-card size plastic with identification information printed or stored thereon. The card may be purchased by customers in multiple denominations such as $1, $5, $10, $20, and $50, or any customer selected card value amounts. For service access, the customer initiates access by swiping the prepaid card into the card reader 28 of the access terminal 10, the access terminal 10 identifies the PIN on the prepaid card from which the charges will be deducted. Alternatively, the customer may pay with a credit card, check card or debit card by swiping it through the card reader 28. The payment is collected from the corresponding service provider of the credit, check or debit card. The accounting and record keeping are performed at a remote central location such as a central billing server in combination with a remote authentication dial-in user service (RADIUS) server which tracks and monitors usage by the customer and records and updates the account information of each prepaid card as will be described herein. The charges incurred by the customer are monitored and tracked by the RADIUS server, and recorded by central billing server. The charges for usage are deducted from the balance amount according to the prevailing charge rate and use of the facsimile transmission services, telephone calling services, Internet computer access services, or ATM/POS financial transactions. For ATM/POS financial transactions such as cash withdrawal, the customer must further provide the bank access card (e.g. ATM/debit or credit card) for identifying the bank account associated with the financial transaction, and the bank PIN for authenticating the bank customer.

In one embodiment of the present invention, there is provided a central billing server with a PIN database for storing account information associated with each PIN. Access to the central billing server is controlled by a remote authentication dial-in user service (RADIUS) server to prevent unauthorized access and control the level of access by authorized classes (e.g. vendor, customer, ATM, personnel, service provider, merchant, prepaid card terminal, and the like). The RADIUS server provides the access terminal 10 with authorization to honor the prepaid card and allow the customer to access the services offered. The central billing server tracks and updates the balance amount of the prepaid card and the usage and time charges incurred by the customer.

The RADIUS server initially receives an access request from the access terminal 10 for providing service along with the PIN of the prepaid card and the customer selected password code previously furnished by the customer. The information is checked and validated by the RADIUS server by accessing the PIN database on the central billing server. The RADIUS server determines the validity of the password code and the sufficiency of the balance amount of the PIN through the PIN database residing on the central billing server. Once the password code is verified and the balance amount is determined to be sufficient, the customer is permitted access by the RADIUS server to the services offer. The RADIUS server then monitors and tracks the access charges and usage time for billing purposes. At the end of the access session, the RADIUS server tallies the usage time and the access charges for the services, and simply deducts the charges from the balance amount and correspondingly updates the remaining balance amount on the PIN database residing on the central billing server. A confirmation is returned to the access terminal 10 for display to the customer.

During the course of the customer access, the RADIUS server tracks and monitors the usage time and the access charges and continuously reviews the balance amount remaining. Upon depletion of the prepaid card balance amount, the RADIUS server immediately terminates access of the access terminal 10. If the balance amount is low, the customer is informed of the low balance amount along with the estimated time remaining for access. The access terminal 10 prompts the customer to replenish the balance amount to prevent termination of the access session. The customer may choose to replenish the balance amount by selecting such option on the access terminal 10. The access terminal 10 retrieves the PIN of the prepaid card previously stored from the prior authentication and verification step. The access terminal 10 prompts the customer to put the currency payment through the currency acceptor 30 and select the debit amount to be added to the balance amount.

The access terminal 10 accesses the RADIUS server for authentication and verification. Upon verification by the RADIUS server, the access terminal 10 transmits the replenishment transaction information to the central billing server. The central billing server updates the balance amount on the PIN database for the prepaid card and returns a confirmation to the access terminal 10 for display to the customer.

Referring to FIG. 3, an access terminal communications network 50 is shown for one embodiment of the present invention for enabling the access terminal 10 to provide the services to the customer. The communications network 50 comprises the access terminal 10 connected to a router 52 through a communications channel 54. The communications channel 54 is preferably a broadband carrier system such as an ethernet network, for providing continuous high-speed data transmission. The router 52 is connected to a global communications network 56 (i.e. Internet). A service provider router or SP router 58 is connected to the global communications network 56 and operates as a central communications hub for redirecting communications traffic from the access terminal 10 to respective locations on the communications network 50.

The SP router 58 is controlled and governed by a remote authentication dial-in user service (RADIUS) server 64 and a central billing server 60 which serves an authentication server. The RADIUS server 64 and the central billing server 60 is connected to the SP router 58 through a communications channel 62 which is preferably a broadband carrier system such as an ethernet network.

The RADIUS server 64 is located between the SP router 58 and the central billing server 60. A RADIUS server a client/server-based authentication software system is used by service providers for remote access applications and allowing the service provider to maintain user profiles in a centralized database. The RADIUS server 64 provides an authentication, authorization, and accounting operations for checking and validating information provided by authorized parties desiring to access the services. The RADIUS server 64 serves as a gatekeeper and prevents unauthorized access to the services. The RADIUS server 64 authenticates and assigns specific access privileges to authorized parties such as the access terminal 10 for accessing the system such as the central billing server 60. The access terminals 10 act as RADIUS clients which connect to the centralized authentication server. This process is carried out for all services including telephone and facsimile calling, Internet computer access, and financial transactions.

The central billing server 60 includes a PIN database for storing all the account data associated with the accounts including user profiles of the prepaid cards. The PIN database records the balance amount remaining in each outstanding prepaid card and is updated by the central billing server 60 for activation of newly sold prepaid cards, and replenishment of the prepaid card balance amount for existing prepaid cards through participating vendors or automated prepaid card implementing terminals. The PIN database residing on the central billing server 60 also stores the PIN of each prepaid card and the corresponding customer-selected password code as well as the usage history of the prepaid card.

The central billing server 60 also maintains records in a separate database of charge rates for the services such as domestic and international call rates, Internet computer access charge rates, financial transaction charge rates, and the like as related to the services offered by the access terminal 10. The charge rates are periodically updated by the service provider. The RADIUS server 64 retrieves the associated service charge rates from the central billing server, tracks the customer's usage, and controls access of the customer. Upon completion of an access session, the RADIUS server 64 terminates access and generates a report containing all the charges accrued and the history of the session. The report is sent to the central billing server 60 where the record is incorporated with the balance amount remaining updated for the corresponding prepaid card that was used for access. For access other than through a prepaid card, the payment amount owed is correspondingly deducted from currency deposited previously through the provision of a debit card, a credit card, a check card, a savings or checking account, or the like, that was provided in lieu of a prepaid card. The central billing server 64 may be configured to implement electronic fund transfer transactions through the appropriate channels. For currency payment, any remaining payment amount is dispensed through a change dispenser or credited to the customer.

In the event that the balance amount on the prepaid card, the currency payment or the like is depleted, the RADIUS server 64 immediately terminates the corresponding access through the SP router 58 from the access terminal 10. The customer is then invited to deposit additional payments in one of the forms described above to re-access the access terminal 10.

Depending on the service accessed, the SP router 58 is adapted to dispatch the communications traffic from the access terminal 10 to the appropriate routes to the desired destination. Upon receiving authorization by the RADIUS server 64 and the central billing server 60, the router 58 identifies the communications traffic as a telephone call, a facsimile transmission, an Internet computer access request, or a financial transaction request.

For telephone and facsimile communications where the destination is a public switch telephone network (PSTN), the communications traffic is directed to a service provider gateway or SP gateway 66 through a communications network 68 which is preferably a broadband carrier system such as an ethernet network. The SP gateway 66 is connected to a PSTN 70 and serves as a entry point into the PSTN 70.

The telephone call or a facsimile transmission call originating from the access terminal 10 is relayed through the global communications network 56 in the form of a series of voice/text/graphic data packets. The data packet also includes a destination telephone number for indicating the destination of the call on the PSTN 70. The PSTN 70 is an analog signal system, and is not compatible for data packet transmission. The SP gateway 62 receives the data packets and dials the destination telephone number and awaits connection to a destination telephone 72 which may be a voice telephone, a facsimile device or another computer.

Upon connection, the SP gateway 62 converts the series of voice/text/graphic data packets into the analog form for transmission to the destination telephone 72. For the communications traffic originating from the PSTN 70 to the access terminal 10, the SP gateway 66 converts the analog form of the traffic to the digital data packet form for transmission through the global communications network 56 back to the access terminal 10. Typically, this process continues back and forth over the course of the connection. During the connection, the RADIUS server 64 is monitoring the call usage time for accruing the charges for the service. If the destination telephone 50 is a video-compatible device, the customer can use the monitor 18 and the camera 26 for a video-audio telephone call exchange. For facsimile transmission calls, the customer can select a document in electronic form which may be retrieved from the global communications network 56, and execute a telephone call as described above. The telephone call is then routed through the Internet to the PSTN 70 via suitable routers and gateways, where the electronic document is transmitted to a destination facsimile device 72 at the destination telephone number located on the PSTN 70.

For access to servers on the global communications network 56, the SP router 58 the communications traffic is directed to an service provider web server or SP web server 74 through a communications channel 76 which is preferably a broadband carrier system such as an ethernet network. The SP web server 74 permits the customer to navigate the global communications network 56 and access a destination web site 78 for transmitting or downloading data. The customer simply keys in the IP address of the destination web site 78 for access through a browser software program running on the access terminal 10. The browser software program such as Netscape Navigator, Microsoft Internet Explorer and the like, is adapted to retrieve and display data from the World Wide Web (WWW). During the Internet computer access connection, the RADIUS server 64 monitors the access usage time accrued to compute the charges for the service.

For executing a financial transaction with a bank or similar financial institution, the customer provides the necessary information by means such as the card reader 28 and the keypad 20. The access terminal 10 forwards the information to an ATM/POS terminal to a host ATM processor. The host ATM processor routes the transaction request to the customer's bank. If the customer requests cash, the host ATM processor causes an electronic fund transfer to take place from the customer's bank account at the bank to the bank account of the host ATM processor. Once the funds are transferred to the bank account of the host ATM processor, the host ATM processor sends an approval code to the access terminal 10 authorizing it to dispense the cash. The host ATM processor transfers the customer's funds using Automated Clearing House procedures, to the bank account of the service provider of the access terminal 10, usually the next business day. Thus reimbursing the service provider for all funds dispensed by the access terminal 10. The term “Automated Clearing House” is a bank terminology and refers to a process where a person or business authorizes another person or business to draft on their account (e.g. small business providing electronic deposit for paychecks) and used conventionally in practice for implementing electronic fund transfer transactions.

With specific reference to FIG. 3, the SP router 58 connects with a service provider finance server, or SP finance server 80 through a communication channel 82. The SP router 58 identifies the financial transaction communication which is the form of a financial transaction instruction packet and directs it to the SP finance server 80. The financial transaction instruction packet is generated by the access terminal 10 and contains financial transaction data comprising, for example, bank account information and security authentication information (e.g. bank PIN) for verification. The customer is requested to place the bank issued card into the card reader 28 and inputting any required information to compose the financial transaction instruction packet. The customer inputs through the key pad 20 to select the type of transactions (cash withdrawals, balance inquiry, etc.) and for what amount. The PIN block is sent in an encrypted form. The information contained within the instruction packet is eventually transmitted from the SP finance server 80 to an ATM/POS terminal 84 connected to an ATM/POS network 86. Typically, the ATM/POS network 86 is a distributed wide area network (WAN) not publicly accessible and is usually equipped with proprietary data transfer protocols and the like. The information contained within the instruction packet is routed to a bank 88 connected to the network 86.

Optionally, the financial transaction instruction packet is encrypted or made electronically tamper-proof to prevent security compromise in the event the packet is intercepted by unauthorized individuals. One suitable encryption technique is called public-key cryptography such as the RSA system, where the packet is enciphered using a key known to the public referred as the public key, yet is decipherable only by those who possess a different key called the private key. In this manner, the access terminal 10 possessing the public key, enciphers the packet and transmits the packet to the SP router 58 which redirects it to the SP finance server 80. The SP finance server 80 possessing the secret private key, is able to decipher the packet to access the contents thereof.

The SP finance server 80 converts the financial transaction instruction packet into a form recognizable and deliverable by the ATM/POS network 86. The converted transaction instruction packet is transmitted to the ATM/POS terminal 84 via a dedicated communications line 90 comprising typically a leased or a dial-up service line. Leased lines connect directly to a host ATM processor 85 on the ATM/POS network 86 through a four wire, point-to-point, dedicated telephone line, and dial up lines connect through a normal telephone line using a modem and a toll free telephone number. Leased lines are preferred for carrying a high volume data communication traffic through-put. The host ATM processor 85 through which the ATM/POS terminal 84 is connected is typically owned by the bank or financial institution or by the ATM service provider. The ATM/POS terminal 84 and the dedicated communications line 90 is typically leased from the corresponding provider of the ATM/POS network 86 for access.

The converted transaction instruction packet typically contains the account information stored on the magnetic stripe on the back of the ATM/debit or credit card. The packet is then transmitted into the ATM/POS network 86 for delivery. The host ATM processor 85 uses the information to route the transaction to the bank 88. The financial transaction instruction packet is forwarded to the corresponding bank 88. The bank 88 extracts the necessary data to execute a standard ATM/POS transaction, in the same manner performed at a conventional automated teller machine or a conventional merchant POS terminal connected to the ATM/POS network 86.

The bank 88 electronically transfers the funds to the bank account of the host ATM processor 85. Upon receipt, the host ATM processor 85 sends an approval code to the access terminal 10 through the ATM/POS terminal 84, the SP finance server and router 80 and 58, respectively, and the global communications network 56. Upon receiving the transaction approval code, the access terminal 10 completes the transaction for the customer (e.g. disbursing the transacted currency amount to the customer for cash withdrawal transactions) through the currency dispenser 32 from a safe containing the cash. The customer is provided with a receipt documenting the transaction from the printer 34. The bill count and all the information pertaining to a particular transaction is recorded in a journal. The journal information is periodically printed out and a hard copy is maintained by the service provider of the access terminal 10. If a dispute should ever arise, the customer is provided with a copy of the journal printout and the host ATM processor 85 is contacted. The host ATM processor 85 is responsible to resolve the dispute.

When a telephone call is completed by the customer and the destination party, the RADIUS server 64 monitoring and tracking the duration of the call prepares a call detail record (CDR) for account processing. The call detail record contains detailed information on the telephone call previously connected through the router 58 and typically includes the number dialed and duration of the call. The CDR is sent to the central billing server 60 and stored on the PIN database residing thereon. Each call event (transfer, connect, disconnect, etc.) gets a time stamp in the CDR. This completes the accounting cycle of the telephone call service.

When an Internet computer access session is completed by the customer, the RADIUS server 64 monitoring and tracking the duration of the session prepares a browsing detail record (BDR) for account processing. The browsing detail record contains detailed information on the Internet servers accessed as connected through the router 58 and typically includes the IP addresses and duration of the session. The BDR is sent to the central billing server 60 and stored on the PIN database residing thereon. Each Internet server access (transfer, connect, disconnect, etc.) gets a time stamp in the BDR. This completes the accounting cycle of the Internet computer access service.

When a financial transaction is completed by the customer, the RADIUS server 64 monitoring and tracking the number of financial transactions performed prepares an ATM detail record (ADR) for account processing. The ATM detail record contains detailed information on the financial transactions connected through the router 58 and typically includes the transaction amount and number of transactions, the financial institutions and the like. The ADR is sent to the central billing server 60 and stored on the PIN database residing thereon. Each transaction event (transfer, connect, disconnect, etc.) gets a time stamp in the ADR. Typically, the charge for this service may be paid out from the associated savings or checking account accessed by the customer if a prepaid card or other forms of payment was not provided. Otherwise, the service charge is deducted from the prepaid card or the balance amount transferred from a debit card, a credit card, currency deposited or the like. This completes the accounting cycle of the financial transaction service through the on-line ATM/POS transaction system.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. An access terminal maintained by a service provider and connected to a global communications network for furnishing telecommunications and automated teller machine (ATM) services to a customer, said access terminal comprising:
a microcontroller for executing preprogrammed instructions and generating directives;
a payment acceptor electrically connected and responsive to said microcontroller for accepting payment from the customer to pay for access to the services;
a multimedia user interface electrically connected and responsive to said microcontroller for enabling exchange of information between the customer and the access terminal during access to said services upon accepting payment from the customer, said multimedia user interface including an ATM interface in one mode of operation for executing an ATM/POS financial transaction by the customer via the global communications network; and
a network interface device electrically connected and responsive to said microcontroller for connecting to a service provider server through the global communications network.

2. The access terminal of claim 1 wherein the multimedia user interface further comprises:
input means for enabling a customer to input information including access to and selection of services; and
output means for conveying information and prompts from the access terminal to the customer.

3. The access terminal of claim 1 wherein the ATM interface comprises:
a display for prompting the customer to input information associated with the execution of the ATM/POS financial transaction;
a card reader in response to the display prompt for reading the information from a bank card and/or a prepaid card; and
a key pad for inputting PIN data of the bank card and/or prepaid card, selecting the type of ATM/POS financial transaction and the amount of the transaction.

4. The access terminal of claim 3 wherein the ATM interface further comprises:
a currency dispenser for dispensing currency to the customer to complete the ATM/POS financial transaction upon receiving an approval code from a bank associated with the transaction; and
a printer for printing a receipt documenting the completed ATM/POS financial transaction in response to dispensing of the currency by the currency dispenser.

5. The access terminal of claim 1 wherein the multimedia user interface further comprises a telephone communication device including a switch-hook, a dialing circuit, a microphone, a speaker, and a hybrid coil, for enabling a telephone exchange with a remote telephonic device via the global communications network upon selection of the service by the customer through the multimedia user interface.

6. The access terminal of claim 2 wherein the input means is selected from the group consisting of push-button dial pads, alphanumeric keyboards, alphanumeric key pads, mouse pointing devices, function key pads, touch screens, cursor tracking devices, camera devices, card readers, and microphones.

7. The access terminal of claim 2 wherein the output means is selected from the group consisting of displays, printers, and speakers.

8. The access terminal of claim 1 wherein the network interface device is interfaces with the global communications network through a communications channel selected from the group consisting of ethernet networks, frame relay networks, synchronous optical network (SONET), asynchronous transfer mode (ATM) networks, digital subscriber loop (xDSL) networks, cable networks, satellite link, T1/T3/E1 trunk lines, integrated services digital network (ISDN), and combinations thereof.

9. The access terminal of claim 1 wherein the payment acceptor is a currency acceptor includes a note acceptor for accepting paper currency.

10. The access terminal of claim 1, wherein the payment acceptor is a card reader for reading indicia stored or printed on a bank or prepaid card which is related to amount of payment available for paying the service access.

11. The access terminal of claim 1 further comprising a camera for taking images of the customer.

12. The access terminal of claim 1 further comprising a memory means for storing advertising information for exhibition through the multimedia user interface.

13. An access terminal network maintained by a service provider for furnishing telecommunications and automated teller machine (ATM) services to a customer, said network comprising:
an access terminal comprising a multimedia user interface for enabling exchange of information between the customer and the access terminal during access to said services, said multimedia user interface including an ATM interface in one mode of operation for executing an ATM/POS financial transaction by the customer;
a remote service provider server connected and in operative communication with a service provider gateway server; and
a global communications network connecting the access terminal and the remote service provider server for facilitating data communication therebetween.

14. The access terminal network of claim 13 wherein the service provider server is connected to an authentication/billing server for monitoring and tracking the access time and the charges associated with the services accessed by the customer through the access terminal.

15. The access terminal network of claim 14 wherein the authentication/billing server stores and manages account data including balance amount in connection with payment through prepaid cards.

16. The access terminal network of claim 14 wherein the authentication/billing server comprises a remote authentication dial-in user service server connected and in operative communication with the service provider server for authenticating, validating and monitoring access of the access terminal to the service provider server and the services.

17. The access terminal network of claim 13 wherein the service provider gateway server is a public switched telephone network (PSTN) gateway connected to a PSTN for providing telephone and facsimile calling service to a destination PSTN telephone device connected to the PSTN, from the access terminal through the global communications network.

18. The access terminal network of claim 13 wherein the service provider gateway server is a service provider web server connected to the global communications network for providing computer access service to a destination computer server, from the access terminal through the global communications network.

19. The access terminal network of claim 18 wherein the destination computer server is a World Wide Web (WWW)-compatible server.

20. The access terminal network of claim 13 wherein the service provider gateway is a service provider finance gateway server connected to an ATM/POS terminal of an ATM/POS network through a dedicated communications channel for executing an ATM/POS financial transaction with a bank connected to the ATM/POS network, from the access terminal through the global communications network.
